(19) United States
(12) Patent Application Publication
(10) Pub. No.: US 2004/0006766 A1
(43) Pub. Date: Jan. 8, 2004

(54) Method and apparatus for installing device driver

(75) Inventor: Young-Gu Kim, Gyeonggi (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-City (KR)

(21) Appl. No.: 10/601,562

(22) Filed: Jun. 24, 2003

(30) Foreign Application Priority Data
Jul. 3, 2002 (KR) 2002-38336

(51) Int. Cl. G06F 9/445; G06F 9/44

(52) U.S. Cl. 717/174; 717/168

(57) ABSTRACT

A method and an apparatus for installing an input device driver by installing the input device driver in the apparatus to drive a device that performs a predetermined function while storing a device driver file, and re-installing the device driver in the apparatus using the stored device driver file. Accordingly, the provided method enables a novice computer user to easily re-install the input device driver using the stored device driver file in the computer without accessing the input device driver file, for example, stored on a CD, thereby improving reliability of the device and reducing the number of after-sale service requests.

### CROSS-REFERENCE TO RELATED APPLICATIONS

This application claims the priority of Korean Patent Application No. 2002-38336, filed Jul. 3, 2002 in the Korean Intellectual Property Office, the disclosure of which is incorporated herein in its entirety by reference.

### BACKGROUND OF THE INVENTION

1. Field of the Invention

The present invention relates to a device driver, such as a printer driver, a scanner driver, or a fax driver, and more particularly, to a method and an apparatus for installing a device driver in a computer.

2. Description of the Related Art

In a conventional method of installing a device driver, for example, a printer driver, when a user inserts a compact disk (CD) including a printer driver file into a computer, a driver installation start image is automatically displayed on a monitor of the computer. Here, if the user presses an installation start button, which issues a command to install a driver, via the driver installation start image, the computer operates (executes) a setup file of the printer driver and installs the printer driver stored on the CD in the computer. In this case, when necessary, the user may re-boot the computer, i.e., initialize the computer again, to complete the installation of the printer driver.

If a problem occurs in the printer driver installed in the computer or a problem occurs in the computer so that the printer driver has to be installed again, the above-described conventional method of installing the printer driver requires the CD including the printer driver file. In other words, in the case where the CD, which is provided when purchasing a printer, is lost, the conventional method of installing the printer driver cannot be used to re-install the printer driver.

In addition, in the case where the printer driver is to be re-installed in the computer, the user has to uninstall the previously installed printer driver, re-boot the computer when necessary, and insert the CD into the computer for reinstallation of the printer driver. Accordingly, it is difficult for a novice to re-install the printer driver by the conventional method.

### SUMMARY OF THE INVENTION

The present invention provides a method of installing a device driver by which the device driver can be easily re-installed in a computer without receiving a device driver file from the outside. The present invention also provides an apparatus that performs the method of installing a device driver according to the present invention.

Additional aspects and advantages of the invention will be set forth in part in the description which follows and, in part, will be obvious from the description, or may be learned by practice of the invention.

According to an aspect of the present invention, there is provided a method of installing a device driver in a computer to drive a device that performs a predetermined function, the method comprising installing the device driver provided from the outside (i.e., input) in the computer while storing a device driver file, and re-installing the device driver in the computer using the stored device driver file.

According to another aspect of the present invention, there is provided a computer installing a device driver in the computer to drive a device that performs a predetermined function, comprising a first driver installation unit, which installs the device driver provided from the outside (i.e., input to the computer) while storing a device driver file, and a second driver installation unit, which re-installs the device driver using the stored device driver file input from the first driver installation.

### BRIEF DESCRIPTION OF THE DRAWINGS

The above and/or other aspects and advantages of the present invention will become apparent and more readily appreciated from the following description of the embodiments, taken in conjunction with the accompanying drawings of which:

FIG. 1 is a flowchart of installing a device driver in a computer, according to an embodiment of the present invention;

FIG. 2 is a flowchart of operation 10 in FIG. 1, according to an embodiment of the present invention;

FIG. 3 is a flowchart of operation 12 in FIG. 1, according to the embodiment of the present invention; and

FIG. 4 is a block diagram of a programmed apparatus installing a device driver, according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below in order to explain the present invention by referring to the figures.

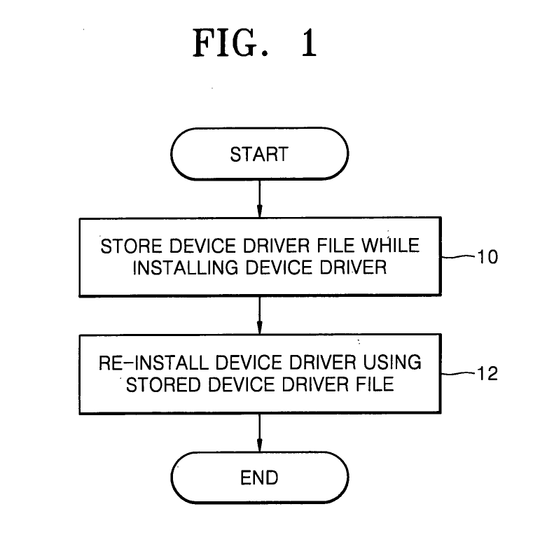

FIG. 1 is a flowchart of installing a device driver in a computer, according to an embodiment of the present invention, the method comprising, at operation 10, storing a device driver file while installing a device driver and, at operation 12, re-installing the device driver using the stored file. The device driver is installed in the computer (not shown) and drives a device (not shown), which is in communication with the computer and performs a predetermined function. Typically, the predetermined function is at least one of a printing function, a scanning function, a faxing function, and a digital image taking function. For example, when the predetermined function is a printing function, the device driver is a printer driver and the device is a printer (not shown). When the predetermined function is a scanning function, the device driver is a scanner driver and the device is a scanner (not shown). When the predetermined function is a faxing function, the device driver is a fax driver and the device is a facsimile device (not shown). When the predetermined function is a digital image taking function, the device driver is a digital camera driver and the device is a digital camera (not shown).

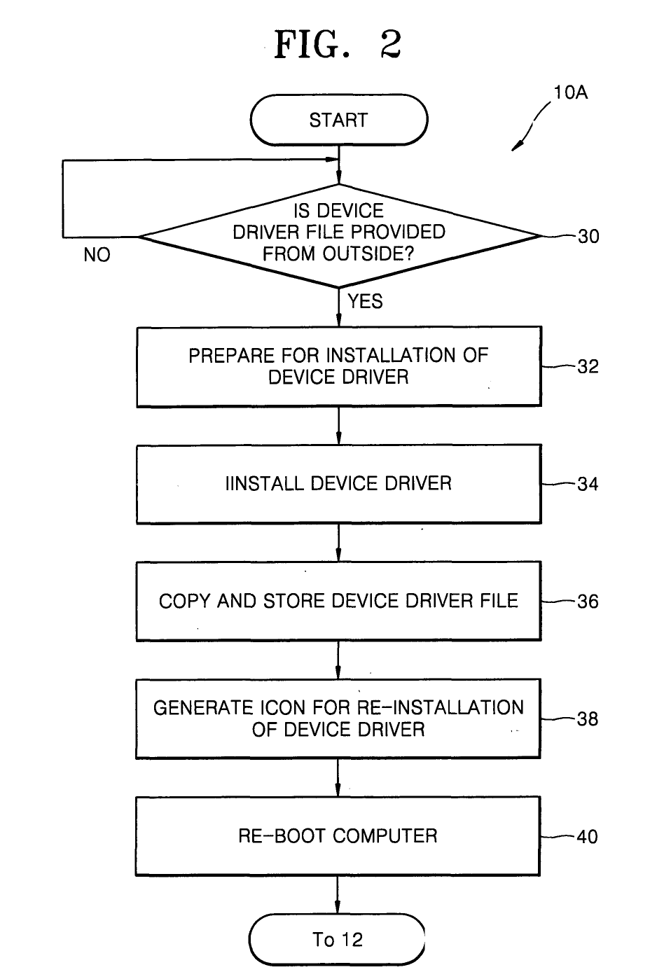

FIG. 2 is a flowchart of operation 10 in FIG. 1, according to an embodiment 10A of the present invention. At operations 30 through 34, the device driver is installed when the device driver file is provided from the outside (i.e., input to the computer), and, at operations 36 through 40, the device driver file is copied and stored in the computer. In particular, at operation 30, it is determined whether the device driver file is provided from the outside. For example, the device driver file may be stored in a compact disk (CD), which is inserted into the computer. In this case, at operation 30, it is determined whether the CD containing the device driver file is inserted into the computer and the device driver file is provided from the inserted CD to the computer.

When, at operation 30, it is determined that the device driver file is provided from the outside, at operation 32, the computer is prepared (i.e., typically, by executing an installation program, such as a setup file, of the device driver provided on the CD) for installing the device driver in the computer. For example, when the CD containing the device driver file is inserted into the computer and the device driver file is provided from the CD, the computer displays an autorun window, i.e., automatically displays an installation start image of the device driver installation program, to the user. Here, the user can request installation of the device driver via the installation start image of the device driver installation program.

As described above, typically, when the CD containing the device driver file is inserted into the computer, the installation start image of the device driver installation program is automatically displayed on the computer monitor. However, according to another aspect of the present invention, at operation 32, the computer may wait for the selection of an executable device driver installation program file with a name such as “setup.exe” by the user, if the CD is inserted into the computer. At operation 34, the device driver (i.e., device driver file) is installed in the computer. In particular, when the user requests the installation of the device driver via the installation start image of the device driver installation program, or selects the “setup.exe” file, the device driver is installed in the computer.

At operation 36, the device driver file, which is provided from the outside and installed at operation 34, is also copied and stored in the computer, for example, in a hard disk drive (HDD) of the computer. At operation 38, after installation of the device driver, an icon for reinstallation of the device driver is generated. Typically, the icon for re-installation of the device driver is connected to the installation program, such as the “setup.exe” file, for the device driver. Accordingly, at operation 38, when the icon for re-installation of the device driver is selected, the “setup.exe” file for the device driver is executed to re-install the device driver from the stored device driver file in the computer, thereby advantageously allowing the user to re-install the device driver as desired, for example, in the case of an error during the previous installation session, etc. In particular, at operation 38, the user may reinstall the device driver without accessing the outside (external to the computer) machine-readable storage initially installing the device driver, such as the CD, the Internet, a network, etc., or without the user uninstalling the previously installed device driver.

At operation 40, the computer is re-booted, and then operation 12 of FIG. 1 is performed. According to an aspect of the present invention, operation 38 may be omitted, so that the device driver re-installation icon is not generated after installation and storage of the device driver file in the computer at operations 34 and 36. Further, according to an aspect of the present invention, operation 40 may be omitted. Typically, known/available processes of the computer, such as operating system processes, are controlled by the installation program, or controlled during installation of the device driver, to generate the device driver re-installation icon and to re-boot the computer. When operations 38 and 40 are omitted, operation 12 of FIG. 1 is performed after operation 36 of FIG. 2 (i.e., a user initiates re-installation of the device driver at a later time after the initial installation). In particular, at operation 12, the device driver is re-installed in the computer using the stored device driver file, thereby re-installing the device driver in the computer using the previously stored device driver file, for example, even if the CD containing the device driver file is not inserted into the computer, and the user has not uninstalled the previously installed device driver.

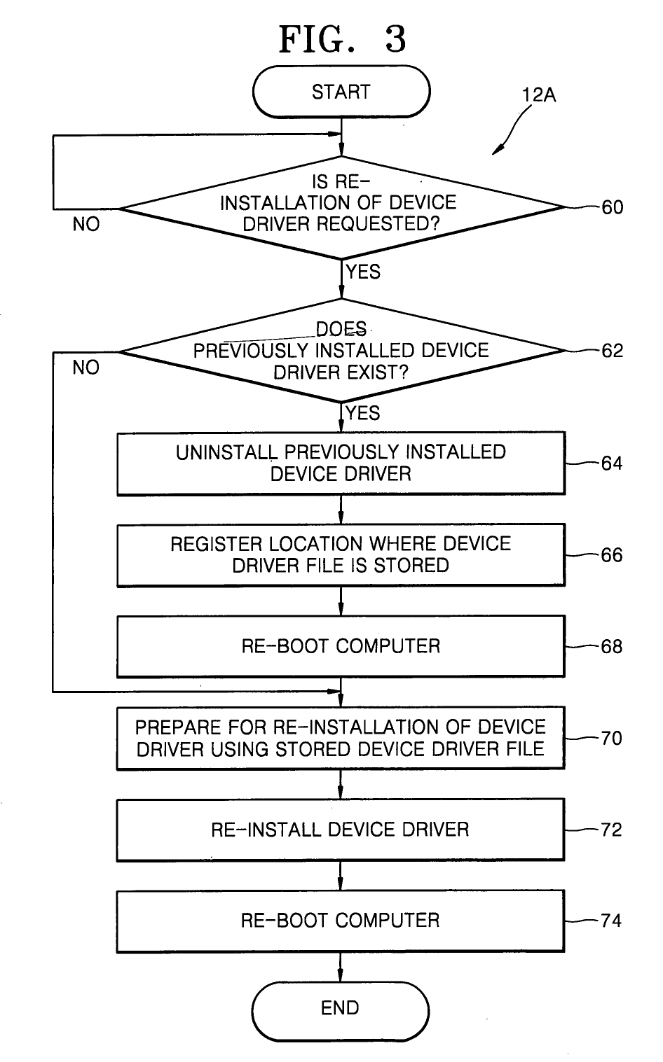

FIG. 3 is a flowchart of operation 12 in FIG. 1, according to an embodiment 12A of the present invention. At operations 60 through 74, the previously installed device driver is uninstalled and then re-installed. In FIG. 1, at operation 12 (i.e., operation 60), it is determined whether the user requests to re-install the device driver in the computer. For example, in FIG. 2, if, at operation 38, the re-installation icon of the device driver is generated, at operation 60, it is determined whether the user selects the re-installation icon of the device driver displayed on a background window of the computer monitor.

When, at operation 60, it is determined that the user requests to re-install the device driver in the computer, i.e., when the icon for re-installation of the device driver is selected, at operation 62, it is determined whether the previously installed device driver exists in the computer. When, at operation 62, it is determined that the previously installed device driver exists in the computer, at operation 64, the previously installed device driver is uninstalled. For example, when, at operation 62, it is determined that the previously installed device driver exists in the computer, at operation 64, the computer may call an uninstall program to uninstall the device driver.

According to an aspect of the present invention, at operation 66, the location in which the device driver file is stored is registered. For example, at operation 66, the location of the “setup.exe” file for the device driver, which is stored in the HDD, is registered in a registry. At operation 68, the computer is re-booted. At operation 68, the “setup.exe” file is registered in the run-once registry to be operated (executed) after the computer is re-booted.

After operation 68 is performed, or when, at operation 62, it is determined that the previously installed device driver does not exist in the computer, at operation 70, the device driver installation program, for example, the registered “setup.exe” file, is executed to re-install the device driver in the computer using the pre-stored device driver file. According to an aspect of the present invention, operations 66 and 68 may be omitted, so that after operation 64, or when, at operation 62, it is determined that the previously installed device driver does not exist in the computer, at operation 70, the computer is prepared (i.e., typically, by executing the device driver installation program, such as the setup.exe program) to re-install the device driver in the computer by using the previously stored device driver file.

At operation 72, the device driver is re-installed in the computer using the pre-stored device driver file. At operation 74, the computer is re-booted. However, according to an aspect of the present invention, operation 74 may be omitted.

Typically, according to the present invention, operations 62 through 74 of FIG. 3 are automatically performed by executing the “setup.exe” file, if the icon for re-installation of the device driver is selected. Thus, even a novice on the computer may automatically re-install the device driver in the computer by selecting the icon for re-installation of the device driver.

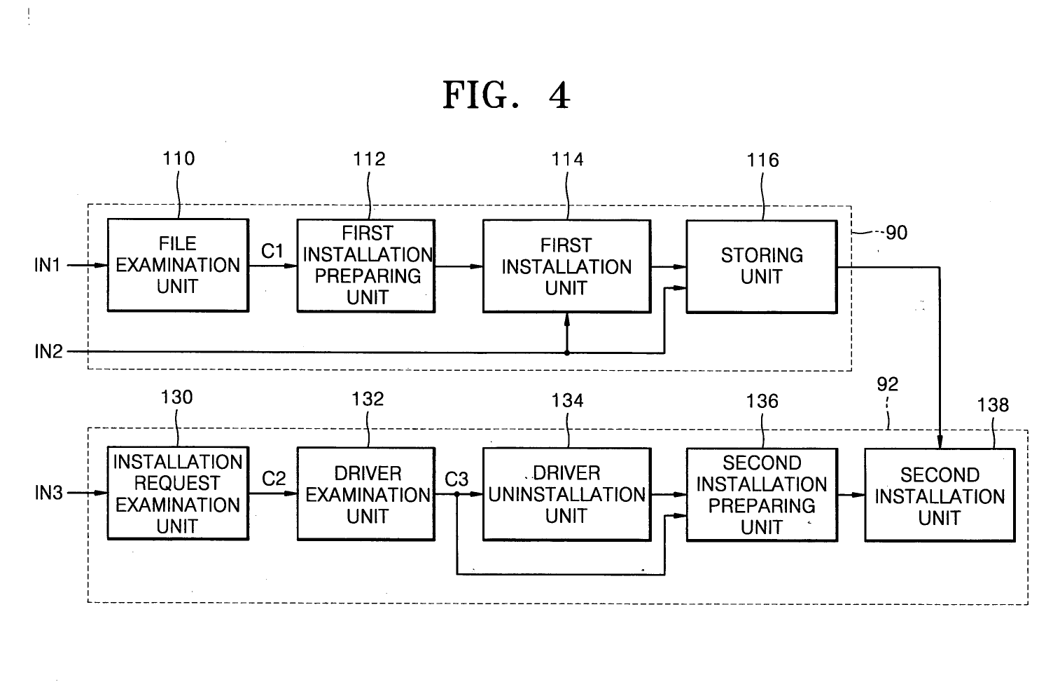

FIG. 4 is a functional block diagram of a programmed apparatus (computer) installing a device driver, according to an embodiment of the present invention. Referring to FIG. 4, the computer comprises a first driver installation unit 90 and a second driver installation unit 92. The installation units 90 and 92 install in the computer a device driver, which drives a device that performs a predetermined function. Typically, the processes of the present invention as embodied in the installation units 90 and 92 are implemented in software, stored on a machine-readable storage for the computer, and executed (installed) to control the computer according to the processes of the invention shown in FIGS. 1 through 3.

To perform operation 10 of FIG. 1, the first driver installation unit 90 installs the device driver input from the outside in the computer and stores the device driver file input from the outside. The first driver installation unit 90 comprises a file examination unit 110, a first installation preparing unit 112, a first installation unit 114, and a storing unit 116. In particular, to perform operation 30 of FIG. 2, the file examination unit 110 examines whether the device driver file is provided from the outside and outputs the examination result as a first control signal C1 to the first installation preparing unit 112. For example, when, at operation 30, the device driver file is input from a CD, the file examination unit 110 examines the insertion of the CD into the computer and the provision of the device driver file from the inserted CD via an input terminal IN1. In addition, the file examination unit 110 outputs the examination result as the first control signal C1.

To perform operation 32, the first installation preparing unit 112 prepares for installation of the device driver, in response to the first control signal C1 input from the file examination unit 110, and outputs a preparation completion signal to the first installation unit 114. The preparation completion signal represents whether the preparation for installation is completed. For example, when, at operation 30, it is determined that the device driver file is provided from the outside based on the first control signal C1, at operation 32, the first installation preparing unit 112 performs operations of preparing for installation of the device driver (i.e., typically, executes a device driver installation program, such as a setup file). At operation 32, the operations of preparing for installation of the device driver may include displaying an autorun window to the user regarding installation of the device driver.

To perform operation 34, the first installation unit 114 installs the device driver in the computer, in response to the preparation completion signal input from the first installation preparing unit 112. For example, when, at operation 34, it is determined that the preparation for installation of the device driver is completed based on the preparation completion signal, the first installation unit 114 installs the device driver, which is input from the outside through an input terminal IN2, in the computer. In particular, typically, the first installation unit 114 installs the device driver in response to the user selecting installation of the device driver in an autorun window of the device driver installation program.

To perform operation 36, when it is determined that the first installation unit 114 completed the installation of the device driver, the storing unit 116 copies and stores the device driver file, which is input through the input terminal IN2. If operations 38 and 40 of FIG. 2 are performed, typically, known/available processes of the computer are controlled to generate the device driver re-installation icon depending upon installation of the device driver, and to re-boot the computer.

Meanwhile, to perform operation 12 of FIG. 1, the second driver installation unit 92 reinstalls the device driver using the stored device driver file, which is input from the first driver installation unit 90. The second driver installation unit 92 comprises an installation request examination unit 130, a driver examination unit 132, a driver uninstallation unit 134, a second installation preparing unit 136, and a second installation unit 138. In particular, to perform operation 60 of FIG. 3, the installation request examination unit 130 examines whether the user requests to re-install the device driver, and outputs the examination result as a second control signal C2 to the driver examination unit 132. For example, at operation 60, an icon selection signal is generated when the user who wants to re-install the device driver selects the icon for re-installation of the device driver. In this case, the installation request examination unit 130 examines whether the icon selection signal is input through an input terminal IN3, and generates the second control signal C2 according to the examination result.

To perform operation 62, the driver examination unit 132 examines whether the previously installed device driver exists in the computer in response to the second control signal C2, and outputs the examination result as a third control signal C3 to the driver uninstallation unit 134. For example, when, at operation 62, it is determined that the user requests to reinstall the device driver based on the second control signal C2, the driver examination unit 132 examines whether the previously installed device driver exists in the computer and outputs the examination result as the third control signal C3 to the driver uninstallation unit 134.

To perform operation 64, the driver uninstallation unit 134 uninstalls the device driver, which is previously installed in the computer, in response to the third control signal C3 input from the driver examination unit 132, and outputs an uninstallation completion signal to the second installation preparing unit 136. The uninstallation completion signal represents whether the uninstallation of device driver is completed. For example, when, at operation 62, it is determined that the previously installed device driver exists in the computer based on the third control signal C3, which is input from the driver examination unit 132, at operation 64, the driver uninstallation unit 134 uninstalls the previously installed device driver from the computer. If operations 66, 68, and 74 of FIG. 3 are performed, typically, known/available processes of the computer are controlled to register storage location of the device drive file, and to re-boot the computer.

To perform operation 70, the second installation preparing unit 136 prepares for reinstallation of the device driver using the stored device driver file, in response to the third control signal C3 input from the driver examination unit 132 and the uninstallation completion signal input from the driver uninstallation unit 134. Thereafter, the second installation preparing unit 136 outputs a preparation completion signal to the second installation unit 138. For example, when, at operation 62, it is determined that the previously installed device driver does not exist based on the third control signal C3, or, at operation 64, the uninstallation of the device driver previously installed in the computer is completed based on the uninstallation completion signal input from the driver uninstallation unit 134, at operation 70, the second installation preparing unit 136 prepares for re-installation of the device driver by running the “setup.exe” file.

To perform operation 72, the second installation unit 138 re-installs the device driver in the computer using the device driver file, which is read from the storing unit 116, in response to the preparation completion signal input from the second installation preparing unit 136. For example, when, at operation 72, it is determined that the preparation for re-installation of the device driver is completed based on the preparation completion signal input from the second installation preparing unit 136, the second installation unit 138 re-installs the device driver in the computer using the stored device driver file, which is read from the storing unit 116.

As described above, the present invention enables a novice computer user to easily re-install a device driver in a computer without having to access a device driver file stored on a CD. In particular, the present invention provides installing in a computer a device driver input to (received by) the computer from an outside information source, such as a CD, storing in the computer a file of the input device driver during the installation of the device driver, and allowing re-installation of the device driver using the stored device driver file, thereby obviating access to the input device driver file. Although in the above described embodiment(s), the device driver is input from a CD, the present invention is not limited to such a configuration, and the device driver may be input from any outside source, such a network, the Internet, other optical recording media, etc. Accordingly, the reliability of a device is improved and the number of after-sale service requests will be reduced.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A method of installing a device driver in a computer to drive a device that performs a predetermined function, the method comprising:
installing in the computer an input device driver while storing a device driver file; and
re-installing the input device driver in the computer using the stored device driver file.

2. The method of claim 1, wherein the installing of the input device driver comprises:
determining whether the device driver file is input;
preparing for installation of the device driver in the computer when determined that the device driver file is input;
installing the input device driver in the computer; and
copying and storing the device driver file in the computer.

3. The method of claim 1, wherein the method further comprises generating an icon for re-installation of the device driver after the device driver file is copied and stored.

4. The method of claim 2, wherein the installing of the input device driver further comprises re-booting the computer after the device driver file is copied and stored.

5. The method of claim 1, wherein the re-installing of the input device driver comprises:
determining whether the device driver is requested to be re-installed in the computer;
determining whether a previously installed device driver exists in the computer, when determined that the device driver is requested to be re-installed in the computer;
uninstalling the previously installed device driver, if determined that the previously installed device driver exists in the computer;
preparing for reinstallation of the device driver in the computer using the stored device driver file, when determined that the previously installed device driver does not exist in the computer or after the previously installed device driver is uninstalled; and
re-installing the device driver in the computer using the stored device driver file.

6. The method of claim 5, wherein the re-installing of the input device driver further comprises:
registering a location where the device driver file is stored, after the previously installed device driver is uninstalled; and
re-booting the computer and preparing for reinstallation of the device driver in the computer using the stored device driver file, according to the location of the device driver file,
wherein the preparing for reinstallation of the device driver in the computer using the stored device driver file comprises preparing for re-installation of the device driver in the computer using the stored device driver file, when determined that the previously installed device driver does not exist in the computer, or after the computer is re-booted.

7. The method of claim 5, wherein the re-installing of the input device driver further comprises re-booting the computer after the device driver is re-installed in the computer.

8. The method of claim 1, wherein the device predetermined function is at least one printing, scanning, faxing, and digital image taking functions.

9. An apparatus installing a device driver to drive a device that performs a predetermined function, the apparatus comprising:
a first driver installation unit installing in the apparatus an input device driver while storing a device driver file; and
a second driver installation unit, which re-installs the device driver using the stored device driver file input from the first driver installation.

10. The apparatus of claim 9, wherein the first driver installation unit comprises:
a file examination unit, which examines whether the device driver file is input and outputs an examination result as a first control signal;
a first installation preparing unit, which prepares for installation of the device driver in response to the first control signal and outputs a preparation completion signal;
a first installation unit, which installs the device driver in response to the preparation completion signal; and
a storing unit, which copies and stores the device driver file.

11. The apparatus of claim 9, wherein the second driver installation unit comprises:
an installation request examination unit, which examines whether a re-installation of the device driver is requested and outputs an examination result as a second control signal;
a driver examination unit, which examines whether a previously installed device driver exists in response to the second control signal and outputs another examination result as a third control signal;
a driver uninstallation unit, which uninstalls the previously installed device driver in response to the third control signal and outputs an uninstallation completion signal representing whether the uninstallation is completed;
a second installation preparing unit, which prepares for re-installation of the device driver using the stored device driver file in response to the third control signal, or in response to the uninstallation completion signal, and outputs a preparation completion signal representing whether the preparation is completed; and
a second installation unit, which re-installs the device driver by reading the stored device driver file in response to the preparation completion signal input from the second installation preparation unit.

12. A machine-readable storage storing at least one program controlling a computing device according to a process comprising:
receiving an input device driver;
installing the input device driver;
storing in the computer a file of the input device driver during the installing of the device driver; and
allowing re-installation of the device driver using the stored device driver file.

13. The machine-readable storage of claim 12, wherein the allowing of the reinstallation comprises:
generating a device driver re-installation icon; and
upon selecting the device driver re-installation icon, re-installing the input device driver using the stored device driver file without accessing the input device driver file.
